(19) United States
(12) Patent Application Publication
(10) Pub. No.: US 2008/0040399 A1
(43) Pub. Date: Feb. 14, 2008

(54) Method and Apparatus for Providing Efficient Space Utilization of WORM Media While Maintaining Transactional Consistency

(76) Inventors: Scott D. Lashley, Portland, OR (US); John F. Miller, Lake Oswego, OR (US); Robert J. Weiman, Castro Valley, CA (US)

Correspondence Address: DILLON & YUDELL, LLP, 8911 N CAPITAL OF TEXAS HWY, SUITE 2110, AUSTIN, TX, 78759, US

(21) Appl. No.: 11/461,703

(22) Filed: Aug. 1, 2006

(51) Int. Cl. G06F 17/30

(52) U.S. Cl. 707/202

(57) ABSTRACT

A method and apparatus for providing efficient space utilization of WORM media while maintaining transactional consistency are disclosed. In response to a transaction, a binary large object (BLOB) associated with the transaction is stored on a staging area of a non-volatile storage medium. A determination is then made as to whether or not a rollback operation needs to be performed on the transaction. If a rollback operation needs not to be performed on the transaction, the BLOB is migrated from the staging area of the non-volatile storage medium to a WORM medium after the transaction has been committed.

### BACKGROUND OF THE INVENTION

1. Technical Field

The present invention relates to database management systems in general, and, in particular, to a database management systems having write once read many (WORM) drives. Still more particularly, the present invention relates to a method and apparatus for providing efficient space utilization of WORM media while maintaining transactional consistency.

2. Description of Related Art

Database management systems (DBMSs) have emerged as an indispensable vehicle for providing efficient data storage and enhanced file maintenance while eliminating data redundancy. A typical DBMS may be designed to store data according to any of a variety of data models, where the data model is the basic organizational concept for the underlying database. The data models for database organization can be divided into several different classes such as hierarchical, network, relational and entity-relationship.

Some DBMSs may include write once read many (WORM) drives, and all transactions must be written to a WORM medium for various reasons, such as satisfying compliance requirements promulgated by governmental authorities. As such, when dealing with binary large objects (BLOBs), a DBMS generally insert the BLOBs prior to inserting the home row piece of data. With such practice, if a rollback operation (either user or system generated) is required after the BLOBs have been inserted in a WORM media, the space on the WORM media will be wasted because there is no delete operation for the WORM media (i.e., the BLOBs cannot be deleted from the WORM media).

Consequently, it would be desirable to provide an improved method and apparatus for providing efficient space utilization of WORM media while maintaining transactional consistency in a DBMS.

### SUMMARY OF THE INVENTION

In accordance with a preferred embodiment of the present invention, in response to a transaction, a binary large object (BLOB) associated with the transaction is stored on a staging area of a non-volatile storage medium. A determination is then made as to whether or not a rollback operation needs to be performed on the transaction. If a rollback operation needs not to be performed on the transaction, the BLOB is migrated from the staging area of the non-volatile storage medium to a WORM medium after the transaction has been committed.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a database system in which a preferred embodiment of the present invention is incorporated;

FIG. 2 is a state diagram of a transaction within the database system of FIG. 1, in accordance with a preferred embodiment of the present invention; and

FIG. 3 is a high-level logic flow diagram of a method for providing efficient space utilization of write once read many (WORM) media, in accordance with a preferred embodiment of the present invention.

### DETAILED DESCRIPTION OF A PREFERRED EMBODIMENT

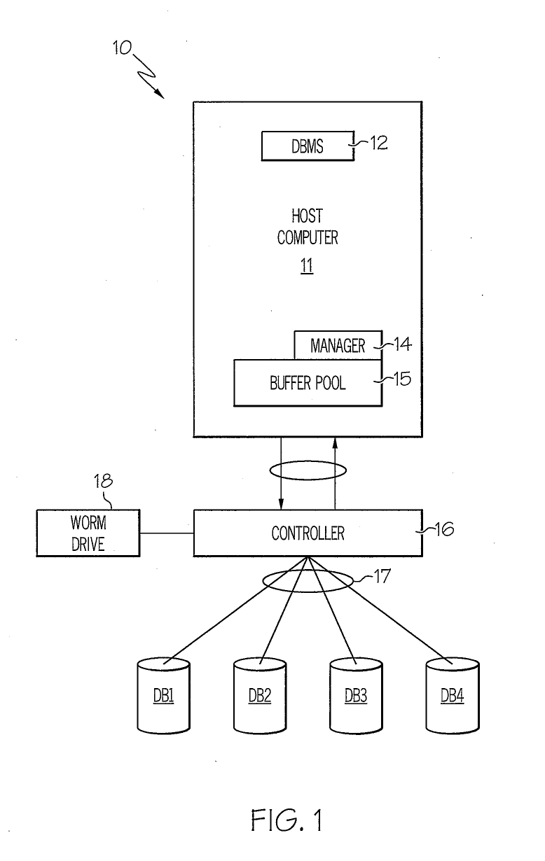

Referring now to the drawings and in particular to FIG. 1, there is depicted a block diagram of a database system in which a preferred embodiment of the present invention is incorporated. As shown, a database system 10 includes a host computer 11 having a database management system (DBMS) 12 and a buffer manager 14 for managing a buffer pool 15. Buffer pool 15 is utilized to cache pages of data returned by a controller 16. Host computer 11 also includes a write once read many (WORM) drive 18 capable of writing data to and reading data from a WORM medium (not shown).

Host computer 11 communicates with controller 16 through a two-way communication channel 13. Controller 16 individually accesses disk drives DB1-DB4, each disk drive being considered as a separate database. Controller 16 communicates with each of disk drives DB1-DB4 via a two-way communication channel collectively designated as channels 17.

Each of disk drives DB1-DB4 includes pages of information holding one or more records on a single page that reside in or are stored in a file. A single database file may have several extents on a single disk. DBMS 12 receives information about the physical disk addresses of the extents belonging to a file on disk drives DB1-DB4 from the operating system.

Typically, there are two DBMS policies of writing a transaction modified page to disk drives DB1-DB4 with respect to its transaction commit processing. For example, if DBMS 12 follows a “force-at-commit” policy, then a transaction is considered committed only after the database pages modified by the transaction have been written to one of disk drives DB1-DB4. DBMS 12 may also follow a “no-force-at-commit” policy. In other words, when a transaction is about to commit, it is not required that the pages modified by the transaction be written to one of disk drives DB1-DB4. For the present invention, DBMS 12 follows the “no-force-at commit” policy.

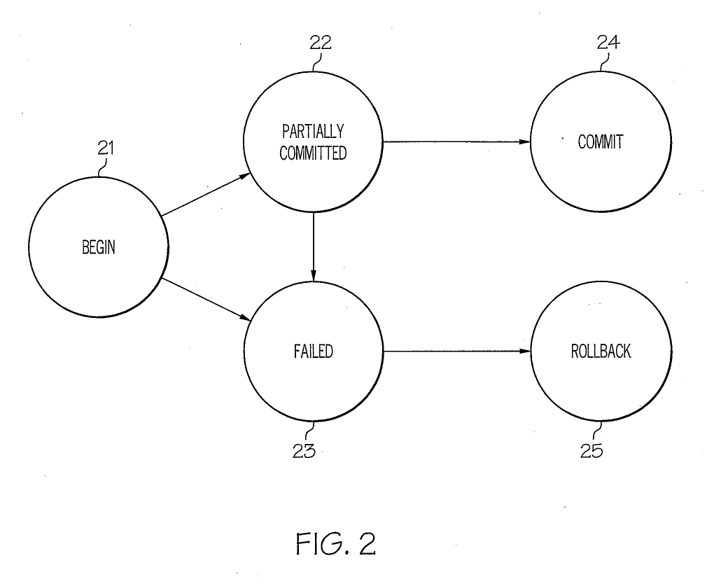

With reference now to FIG. 2, there is illustrated a state diagram of a transaction within database system 10 from FIG. 1, in accordance with a preferred embodiment of the present invention. A transaction starts in a Begin (in-flight) state 21. When the transaction reaches its last statement, it enters a Partially Committed state 22. At such point, the transaction has completed its execution, but it is still possible that it may have to be aborted. Writes to a WORM medium take place only after a transaction has entered a Commit state 24. One way to implement such a scheme is to temporarily store any value associated with such writes to a non-volatile storage device, and the actual writes are performed only at Commit state 24. A committed transaction will then be able to complete its write except in the case of a hardware failure.

The transaction enters a Failed stage 23 after it is determined that the transaction cannot proceed with normal execution, for example, due to hardware or logical errors or due to a user request, and the transaction must be rollback. Once a rollback has occurred, the transaction enters a Rollback state 25.

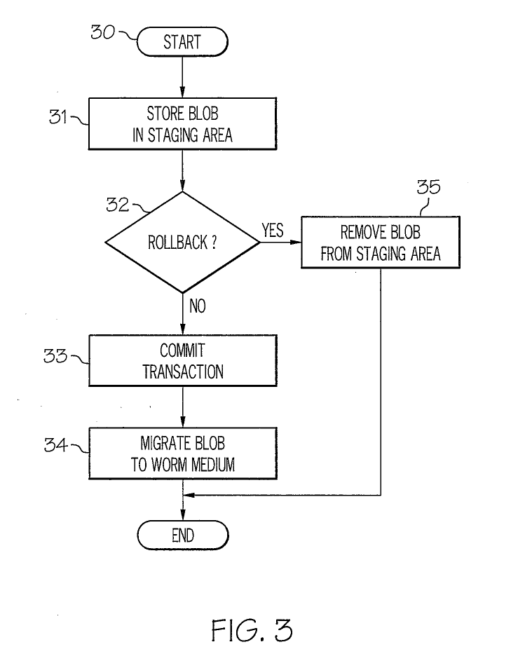

Referring now to FIG. 3, there is illustrated a high-level logic flow diagram of a method for providing efficient space utilization of a WORM medium, in accordance with a preferred embodiment of the present invention. Starting at block 30, in response to a transaction, a binary large object (BLOB) associated with the transaction is initially stored on a staging area of a non-volatile storage medium, such as one of disk drives DB1-DB4 from FIG. 1, as shown in block 31. A determination is then made as to whether or not a rollback operation needs to be performed on the transaction, as depicted in block 32. If a rollback operation is not required on the transaction, and a commit operation is performed on the transaction, as shown in block 33. Subsequently, a BLOB associated with the transaction is migrated from the staging area of the non-volatile storage medium to a WORM medium any time after the transaction has been committed, as depicted in block 34. Such time can be seconds, minutes, hours or days.

Otherwise, if a rollback operation is required on the transaction, the BLOB is removed from the staging area of the non-volatile storage medium, as depicted in block 35. This is done in a separate transaction so there will be no possibility for data loss and no delay caused to the original transaction.

As has been described, the present invention provides an improved method and apparatus for providing efficient space utilization of WORM media in a DBMS while maintaining transactional consistency of the DBMS. Since BLOBs of a transaction will not be transferred to a WORM medium until the transaction associated with the BLOBs has been committed, no space on the WORM medium will be wasted even if a rollback operation is required for the transaction. After the transaction has been completed successfully, a separate system thread (transaction) asynchronously migrates the BLOBs from the non-volatile storage medium to the WORM medium.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for providing efficient space utilization of a write once read many (WORM) medium in a database management system (DBMS), said method comprising:
in response to a transaction, storing data associated with said transaction on a staging area of a non-volatile storage medium;
determining whether or not a rollback operation needs to be performed on said transaction;
in a determination that a rollback operation needs not to be performed on said transaction, migrating said data from said staging area of said non-volatile storage medium to a WORM medium after said transaction has been committed.

2. The method of claim 1, wherein said migrating further includes purging said data from said staging area of said non-volatile storage medium.

3. The method of claim 1, wherein said method further includes in a determination that a rollback operation needs to be performed on said transaction, deleting said data from said staging area of said non-volatile storage medium.

4. The method of claim 1, wherein said non-volatile storage medium is a hard drive.

5. The method of claim 1, wherein said data is a binary large object.

6. A computer usable medium having a computer program product for providing efficient space utilization of a write once read many (WORM) medium in a database management system (DBMS), said computer usable medium comprising:
program code means for storing, in response to a transaction, data associated with said transaction on a staging area of a non-volatile storage medium;
program code means for determining whether or not a rollback operation needs to be performed on said transaction;
in a determination that a rollback operation needs not to be performed on said transaction, program code means for migrating said data from said staging area of said non-volatile storage medium to a WORM medium after said transaction has been committed.

7. The computer usable medium of claim 6, wherein said program code means for migrating further includes program code means for purging said data from said staging area of said non-volatile storage medium.

8. The computer usable medium of claim 6, wherein said computer usable medium further includes in a determination that a rollback operation needs to be performed on said transaction, program code means for deleting said data from said staging area of said non-volatile storage medium.

9. The computer usable medium of claim 6, wherein said non-volatile storage medium is a hard drive.

10. The computer usable medium of claim 6, wherein said data is a binary large object.

11. A database management system (DBMS) having a write once read many (WORM) medium, said DBMS comprising:
means for storing, in response to a transaction, data associated with said transaction on a staging area of a non-volatile storage medium;
means for determining whether or not a rollback operation needs to be performed on said transaction;
in a determination that a rollback operation needs not to be performed on said transaction, means for migrating said data from said staging area of said non-volatile storage medium to a WORM medium after said transaction has been committed.

12. The DBMS of claim 11, wherein said means for migrating further includes means for purging said data from said staging area of said non-volatile storage medium.

13. The DBMS of claim 11, wherein said DBMS further includes in a determination that a rollback operation needs to be performed on said transaction, means for deleting said data from said staging area of said non-volatile storage medium.

14. The DBMS of claim 11, wherein said non-volatile storage medium is a hard drive.

15. The DBMS of claim 11, wherein said data is a binary large object.
